(19) United States
(12) Patent Application Publication
(10) Pub. No.: US 2024/0317584 A1
(43) Pub. Date: Sep. 26, 2024

(54) MANUFACTURING METHOD OF CARBON-COATED LITHIUM IRON PHOSPHATE MATERIAL

(71) Applicant: Advanced Lithium Electrochemistry Co., Ltd., Taoyuan City (TW)

(72) Inventors: Ya-Hui Wang, Taoyuan City (TW); Feng-Yen Tsai, Taoyuan City (TW)

(21) Appl. No.: 18/227,444

(22) Filed: Jul. 28, 2023

(30) Foreign Application Priority Data
Mar. 21, 2023 (TW) 112110482

(51) Int. Cl. C01B 25/45; C01B 25/26

(52) U.S. Cl. CPC C01B 25/45; C01B 25/265

(57) ABSTRACT

A manufacturing method of a carbon-coated lithium iron phosphate material is disclosed. The manufacturing method includes steps of: (a) providing a first slurry, a carbon source and a lithium source, wherein the first slurry is formed from an iron source and a phosphorus source; (b) mixing the first slurry, the carbon source and the lithium source to form a second slurry, and grinding the second slurry in a tank at a first temperature to form a third slurry, wherein the first temperature is ranged from 25° C. to 40° C.; and (c) drying and sintering the third slurry to form the carbon-coated lithium iron phosphate material including a core layer and a coating layer coated on the core layer, wherein the core layer is formed from the lithium source, the iron source and the phosphorus source, and the coating layer is formed from the carbon source.

### CROSS-REFERENCE TO RELATED APPLICATION

This application claims priority to Taiwan Patent Application No. 112110482, filed on Mar. 21, 2023. The entire contents of the above-mentioned patent application are incorporated herein by reference for all purposes.

### FIELD OF THE INVENTION

The present disclosure relates to a manufacturing method of a cathode material, and more particularly to a manufacturing method of a carbon-coated lithium iron phosphate material.

### BACKGROUND OF THE INVENTION

Lithium-ion batteries are widely used in the field of energy storage due to their excellent cycling performance and high energy density. Among the various types of lithium-ion batteries, those that utilize the lithium iron phosphate (LiFePO₄) as the positive electrode material offer advantages such as low material cost and high safety, making them a highly promising type. However, the olivine structure of the lithium iron phosphate leads to lower lithium-ion diffusion rate and electronic conductivity, thereby restricting the application of the lithium iron phosphate.

To overcome the mentioned limitations, the industry has adopted the carbon coating process to enhance the performance of lithium iron phosphate. However, in the conventional carbon coating process, the alkaline nature of the lithium-containing slurry and the temperature rise during the grinding process lead to oxidation and decomposition of the carbon source in the alkaline and high-temperature environment. Additionally, temperature fluctuations during the grinding process affect the solubility of the lithium salt in the slurry, leading to a decline in the overall stability of the carbon-coated lithium iron phosphate material. As a result, the traditional carbon coating processes yield carbon-coated lithium iron phosphate materials with insufficient carbon content and unstable quality.

Therefore, there is a need to provide a manufacturing method of a carbon-coated lithium iron phosphate material that effectively regulates the slurry temperature, thereby ensuring optimal carbon content and enhancing the stability of the product quality.

### SUMMARY OF THE INVENTION

An object of the present disclosure is to provide a manufacturing method of a carbon-coated lithium iron phosphate material that effectively regulates the slurry temperature, thereby ensuring optimal carbon content and enhancing the stability of the product's quality. First, a carbon source, a lithium source, and a slurry formed from an iron source and a phosphorus source is provided. Next, the first slurry, the carbon source and the lithium source are mixed to form a second slurry. The second slurry is then ground in a tank at a temperature ranged from 25° C. to 40° C. to form a third slurry. Finally, the third slurry is dried and sintered to form a carbon-coated lithium iron phosphate material. By controlling the slurry temperature within a specific temperature range, the consistency of the lithium source solubility in the slurry is ensured, while avoiding the oxidation and decomposition of the carbon source in the high-temperature environment. As a result, the carbon content of the carbon-coated lithium iron phosphate material is guaranteed, thereby enhancing the stability of the product quality. Furthermore, the slurry temperature is controlled by employing liquid cooling method through a cooling jacket. The cooling jacket surrounds the internal space of the tank where the slurry is accommodated, ensuring smooth and uniform temperature control, thereby further enhances the stability of the product quality.

In accordance with an aspect of the present disclosure, a manufacturing method of a carbon-coated lithium iron phosphate material is provided. The manufacturing method of the carbon-coated lithium iron phosphate material includes: (a) providing a first slurry, a carbon source and a lithium source, wherein the first slurry is formed from an iron source and a phosphorus source; (b) mixing the first slurry, the carbon source and the lithium source to form a second slurry, and grinding the second slurry in a tank at a first temperature to form a third slurry, wherein the first temperature is ranged from 25° C. to 40° C.; and (c) drying and sintering the third slurry to form the carbon-coated lithium iron phosphate material including a core layer and a coating layer coated on the core layer, wherein the core layer is formed from the lithium source, the iron source and the phosphorus source, wherein the coating layer is formed from the carbon source.

In an embodiment, a liquid cooling method is performed to control the first temperature.

In an embodiment, the tank further comprises a first chamber and a cooling jacket. The second slurry and the third slurry are accommodated in the first chamber for mixing and grinding, the cooling jacket is disposed to surround the first chamber, and the liquid cooling method is performed through the cooling jacket.

In an embodiment, the cooling jacket comprises at least two channels and a second chamber, wherein the second chamber is connected between at least two channels and disposed to surround the first chamber, and a liquid flows into and out of the second chamber through the at least two channels.

In an embodiment, the carbon source, the lithium source and the first slurry are ground by a ball milling method.

In an embodiment, the second slurry and the third slurry are alkaline.

In an embodiment, the iron source includes an iron powder, the phosphorus source includes a phosphoric acid solution, and the iron powder and the phosphoric acid solution are reacted to form the first slurry.

In an embodiment, the third slurry is dried by a spray drying method.

In an embodiment, the third slurry is sintered at a sintering temperature ranged from 550° C. to 750° C.

In an embodiment, the third slurry is sintered in a non-oxidizing atmosphere.

In an embodiment, the carbon-coated lithium iron phosphate material has a carbon content of ranged from 1.0% to 1.6%.

### BRIEF DESCRIPTION OF THE DRAWINGS

FIG. 1 is a flow chart of a manufacturing method of a carbon-coated lithium iron phosphate material according to an embodiment of the present disclosure;

FIG. 2A is a schematic structural view of a tank according to an embodiment of the present disclosure; and

FIG. 2B is a cross-sectional view along the A-A′ line of FIG. 2A.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed. In addition, although the “first,” “second,” “third,” and the like terms in the claims be used to describe the various elements can be appreciated, these elements should not be limited by these terms, and these elements are described in the respective embodiments are used to express the different reference numerals, these terms are only used to distinguish one element from another element. For example, a first element could be termed a second element, and, similarly, a second element could be termed a first element, without departing from the scope of example embodiments. Besides, “and/or” and the like may be used herein for including any or all combinations of one or more of the associated listed items. Alternatively, the word “about” means within an acceptable standard error of ordinary skill in the art-recognized average. In addition to the operation/working examples, or unless otherwise specifically stated, in all cases, all of the numerical ranges, amounts, values and percentages, such as the number for the herein disclosed materials, time duration, temperature, operating conditions, the ratio of the amount, and the like, should be understood as the word “about” decorator. Accordingly, unless otherwise indicated, the numerical parameters of the present invention and scope of the appended patent proposed is to follow changes in the desired approximations. At last, the number of significant digits for each numerical parameter should at least be reported and explained by conventional rounding technique is applied. Herein, it can be expressed as a range between from one endpoint to the other or both endpoints. Unless otherwise specified, all ranges disclosed herein are inclusive.

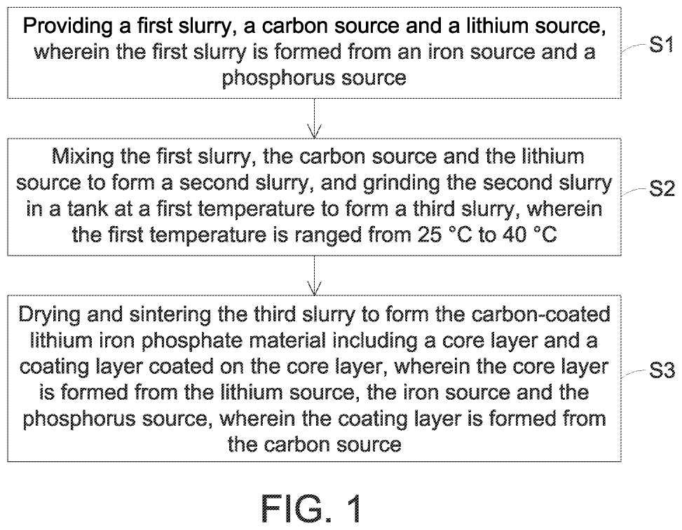

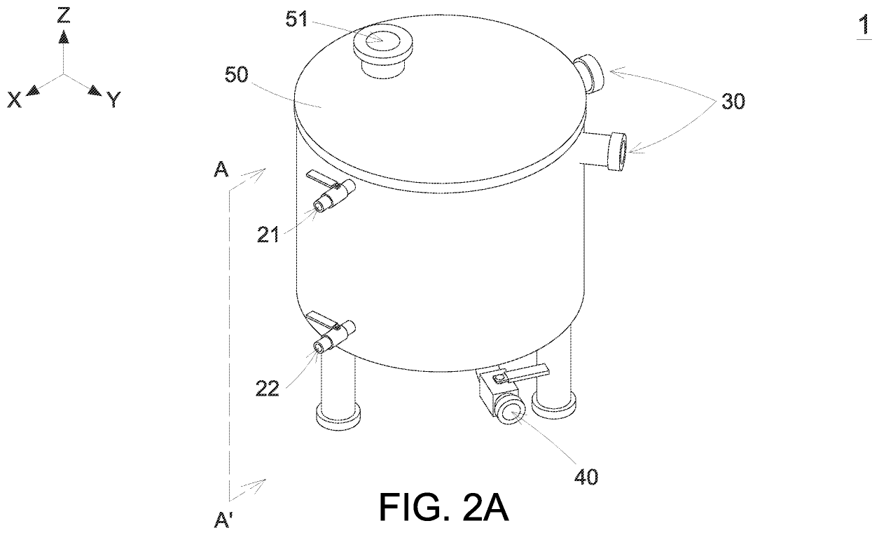

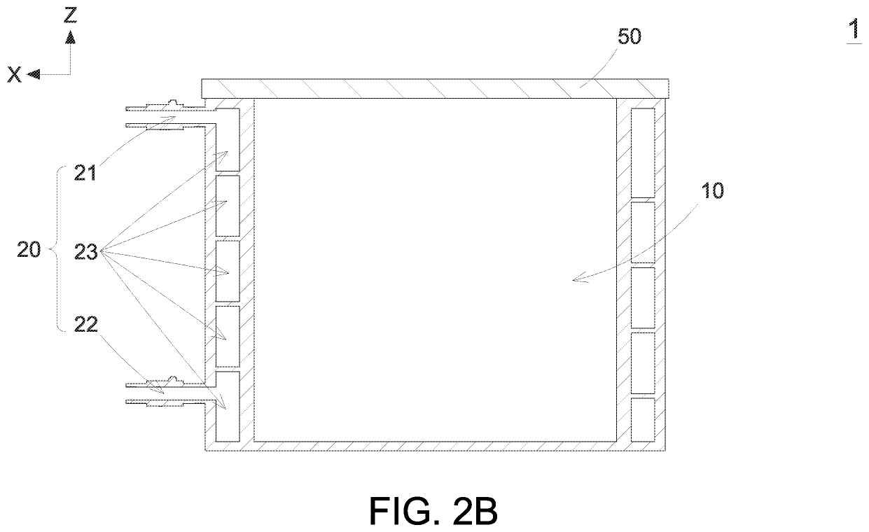

Refer to FIGS. 1 to 2B. FIG. 1 is a flow chart of a manufacturing method of a carbon-coated lithium iron phosphate material according to an embodiment of the present disclosure. FIG. 2A is a schematic structural view of a tank according to an embodiment of the present disclosure. FIG. 2B is a cross-sectional view along the A-A′ line of FIG. 2A. In the embodiment, the manufacturing method of the carbon-coated lithium iron phosphate material includes following steps. First, as shown in the step S1, a first slurry, a carbon source, and a lithium source are provided. The first slurry is formed from an iron source and a phosphorus source. In the embodiment, the iron source includes an iron powder, the phosphorus source includes a phosphoric acid (H₃PO₄), and the iron powder and a phosphoric acid solution are reacted to form the first slurry. Preferably but not exclusively, the reaction time is ranged from 17 hours to 24 hours, so as to form a more stable first slurry. The carbon source is a water-soluble carbohydrate, including but not limited to a glucose, a fructose, a galactose, a sucrose, a maltose, or a lactose. The lithium source is a lithium salt, including but not limited to a lithium hydroxide (LiOH), a lithium carbonate (Li₂CO₃), a lithium nitrate (LiNO₃), or a lithium chloride (LiCl). In other embodiments, the lithium source is a combination of multiple different lithium salts. The present disclosure is not limited thereto.

Next, as shown in the step S2, the first slurry, the carbon source and the lithium source are mixed to form a second slurry. The second slurry is then ground in a tank 1 at a first temperature to form a third slurry. The first temperature is ranged from 25° C. to 40° C., preferably from 27° C. to 35° C. In the embodiment, the first slurry, the carbon source and the lithium source are mixed and reacted to form the second slurry at a second temperature. The second temperature is equal to or below 50° C., preferably ranged from 30° C. and 50° C. The second slurry is ground by a ball milling method for 9 to 12 hours to form the third slurry. The third slurry has a median particle size (D50) of 1.0 μm. The second slurry and the third slurry are alkaline. Notably, the grinding conditions and the median particle size (D50) of the third slurry are not limited thereto, and are adjustable according to specific requirements or needs.

In the embodiment, the tank 1 includes a first chamber 10 and a cooling jacket 20. The second slurry and the third slurry are accommodated in the first chamber 10, and the cooling jacket 20 is disposed to surround the first chamber 10. Preferably but not exclusively, a liquid cooling method is performed to control the first temperature through the cooling jacket 20. The cooling jacket 20 includes a second chamber 21, a first channel 22 and a second channel 23. The second chamber 21 is connected between the first channel 22 and the second channel 23 and is disposed to surround the first chamber 10. In the embodiment, the second chamber is a spiral channel concentrically disposed with the first chamber 10, forming a ring shape that encircles the first chamber 10. A liquid flows into and out of the second chamber 21 through the first channel 22 and the second channel 23.

In the embodiment, the liquid flows into the second chamber 21 through the first channel 22, and the heat generated from the second slurry in the first chamber 10 is transferred to the second chamber 21 and absorbed by the liquid therein. After absorbing the heat, the liquid flows out of the second chamber 21 through the second channel 23. The temperature of the second slurry in the tank 1 is regulated by the circulation of the liquid in the cooling jacket 20 of the tank 1. Furthermore, the second chamber 21 is disposed to surround the first chamber 10. The liquid flows through the second chamber 21, and the slurry is accommodated in the first chamber 10. The arrangement ensures smooth and uniform temperature control, which guarantees consistent solubility of the lithium source in the slurry and avoids oxidation and decomposition of the carbon source within high-temperature environments.

In the embodiment, the first channel 22 is disposed at an upper part of the tank 1, and the second channel 23 is disposed at a lower part of the tank 1. The first channel 22 and the second channel 23 are disposed in a vertical direction (i.e., the Z-axis direction).

In another embodiment, the liquid flows into the second chamber 21 through the first channel 22 and flows out of the second chamber 21 through the second channel 23. The first channel 22 and the second channel 23 are both disposed at an upper part of the tank 1.

In another embodiment, the liquid flows into the second chamber 21 through the first channel 22 and flow out of the second chamber 21 through the second channel 23. The first channel 22 and the second channel 23 are both disposed at a lower part of the tank 1.

In another embodiment, the liquid flows into the second chamber 21 through two first channels 22 and flow out of the second chamber 21 through two second channels 23. The two first channels 22 are disposed along the vertical direction (i.e., the Z-axis direction). One of the two first channels 22 is disposed at an upper part of the tank 1, and the other one of the two first channels 22 is disposed at a lower part of the tank 1. The two second channels 23 are disposed along the vertical direction (i.e., the Z-axis direction). One of the two second channels 23 is disposed at an upper part of the tank 1, and the other one of the two second channels 23 is disposed at a lower part of the tank 1. Notably, the number and the arrangement of the channels are not limited thereto, and are not redundantly described herein.

In the embodiment, the tank 1 further includes an inlet port 30, an outlet port 40 and a cover 50. The inlet port 30 and the outlet port 40 are each connected to the first chamber 10. A grinding unit (not shown in the figures) is connected to the inlet port 30 and the outlet port 40, establishing a connection with the first chamber 10. During the mixing and grinding process, the second slurry exits the first chamber 10 through the outlet port 40 and enters the grinding unit for grinding. Subsequently, the first slurry leaves the grinding unit through the inlet port 30 and re-enters the first chamber 10 for mixing and cooling. In this way, continuous cooling of the slurry throughout the mixing and grinding process is achieved, resulting in smooth and uniform temperature control and enhanced stability of the product quality.

The cover 50 is disposed above the first chamber 10 to shield the first chamber 10 along the vertical direction (i.e., the Z-axis direction), preventing impurities or foreign substances from contaminating the slurry during the process. In the embodiment, the cover 50 further includes a through hole 51. The solid lithium salts are introduced into the first chamber 10 through the through hole 51. In other embodiments, the cover 50 includes a plurality of through holes 51, each of which has a unique diameter. The solid lithium salts are introduced into the first chamber 10 through the plurality of through holes 51, and a thermometer is inserted into the first chamber 10 through the plurality of through holes 51 for measuring the slurry temperature. The present disclosure is not limited thereto. Notably, the carbon source, the lithium source and the first slurry may be mixed and reacted in the tank 1 to form the second slurry having the second temperature equal to or below 50° C.

Finally, as shown in the step S3, the third slurry is dried and sintered to form the carbon-coated lithium iron phosphate material. The carbon-coated lithium iron phosphate material includes a core layer and a coating layer coated on the core layer. The core layer is formed from the lithium source, the iron source and the phosphorus source, and the coating layer is formed from the carbon source. In the embodiment, the product obtained from the previous step is dried by a spray drying method. Subsequently, it is sintered at a temperature ranged from 550° C. and 750° C. in a non-oxidizing atmosphere for a duration of 7 to 15 hours. The carbon-coated lithium iron phosphate material has a carbon content ranged from 1.0% to 1.6%. Certainly, the drying method, sintering conditions, and the percentage of the carbon content of the carbon-coated lithium iron phosphate material are not limited thereto, and are adjustable according to specific requirements or needs.

The manufacturing method and the effects of the present disclosure are further described in detail below through demonstrative examples and comparative examples.

### First Demonstrative Example

First, a first slurry, a carbon source and a lithium source are provided. The first slurry is formed by reacting 5585 grams of iron powder, 11529 grams of 85% phosphoric acid solution, and 40 liters of deionized water in a tank for a duration of 20 hours. In the first demonstrative example, target specifications for the carbon-coated lithium iron phosphate material include a weight of 1578 grams and a carbon content of 1.30%. Notably, during the sintering process, 50% of the carbon content is lost. Therefore, the carbon content in the carbon-coated lithium iron phosphate material is half of the carbon content in the third slurry. To achieve the target specification, 41.0 grams of carbon needs to be added as the carbon source. Furthermore, in the first demonstrative example, the carbon source is a glucose, where carbon atoms account for 40% of its molecular mass. Consequently, 102.5 grams of glucose is required to yield the desired 41.0 grams of carbon. The lithium source is 1197 grams of lithium hydroxide (LiOH) and 1847 grams of lithium carbonate (Li₂CO₃). The 5585 grams of iron powder contains 100 moles of iron, while the 11529 grams of 85% phosphoric acid solution contains 100 moles of phosphorus. The combination of the 1197 grams of lithium hydroxide and the 1847 grams of lithium carbonate contains 100 moles of lithium. These components are used to produce 100 moles of lithium iron phosphate.

Next, the 102.5 grams of glucose, the 1197 grams of lithium hydroxide (LiOH) and the 1847 grams of lithium carbonate (Li₂CO₃) are added to the mixing first slurry, and are reacted to form a second slurry. Subsequently, the second slurry is ground by a ball milling method to form a third slurry. During the grinding process, a liquid cooling method is performed to control the temperature of the second slurry through the cooling jacket of the tank. The temperature of the second slurry is maintained at 25° C. The third slurry has a median particle size (D50) of 1.0 μm.

Finally, the third slurry is dried and sintered to form a carbon-coated lithium iron phosphate. The third slurry is dried by a spray drying method, and is sintered at a temperature ranged from 550° C. and 750° C. in a nitrogen atmosphere for a duration of 10 hours to form a carbon-coated lithium iron phosphate. The carbon-coated lithium iron phosphate material of the first demonstrative example is subjected to a BET specific surface area test, which yields a measured specific surface area of 9.60 cm²/g. The carbon-coated lithium iron phosphate material of the first demonstrative example is subjected to an elemental analysis, which yields a measured carbon content of 1.15%.

### First Comparative Example

The manufacturing method of the first comparative example is roughly similar to that of the first demonstrative example. However, in the first comparative example, the temperature of the second slurry is maintained at 45° C. The carbon-coated lithium iron phosphate material of the first comparative example is subjected to a BET specific surface area test, which yields a measured specific surface area of 8.58 cm²/g. The carbon-coated lithium iron phosphate material of the first comparative example is subjected to an elemental analysis, which yields a measured carbon content of 1.02%.

Refer to table 1 below. Table 1 presents the slurry temperature (° C.), BET surface area (cm²/g), and carbon content (%) of the carbon-coated lithium iron phosphate materials of the first demonstrative example and the first comparative example. Compared to the target specification of the carbon content of 1.30%, the carbon loss rate of the carbon-coated lithium iron phosphate material of the first demonstrative example is 11.5%, while the carbon loss rate of the carbon-coated lithium iron phosphate material of the first comparative example is 21.5%. Obviously, the carbon loss of the first demonstrative example with the slurry temperature of 25° C. is lower than that of the first comparative example with the slurry temperature of 45° C., and the specific surface area of the carbon-coated lithium iron phosphate material of the first demonstrative example is higher than that of the first comparative example. Namely, by implementing the liquid cooling method through the water jacket to control the slurry temperature between 25° C. to 40° C., the consistency of the lithium source solubility in the slurry is ensured, while avoiding the oxidation and decomposition of the carbon source in the high-temperature environment. As a result, the carbon content of the carbon-coated lithium iron phosphate material is guaranteed, thereby enhancing the stability of the product quality.

TABLE 1

| | Slurry | Specific | Carbon |
|---|---|---|---|
| | temperature | surface area | content |
| First demonstrative example | 25° C. | 9.60 cm²/g | 1.15% |
| First comparative example | 45° C. | 8.58 cm²/g | 1.02% |

### Second Demonstrative Example

First, a first slurry, a carbon source and a lithium source are provided. The first slurry is formed by reacting 5585 grams of iron powder, 11529 grams of 85% phosphoric acid solution, and 40 liters of deionized water in a tank for a duration of 20 hours. In the second demonstrative example, target specifications for the carbon-coated lithium iron phosphate material include a weight of 1578 grams and a carbon content of 1.40%. Notably, during the sintering process, 50% of the carbon content is lost. Therefore, the carbon content in the carbon-coated lithium iron phosphate material is half of the carbon content in the third slurry. To achieve the target specification, 44.2 grams of carbon needs to be added as the carbon source. Furthermore, in the second demonstrative example, the carbon source is a glucose, where carbon atoms account for 40% of its molecular mass. Consequently, 110.5 grams of glucose is required to yield the desired 44.2 grams of carbon. The lithium source is 1197 grams of lithium hydroxide (LiOH) and 1847 grams of lithium carbonate (Li₂CO₃). The 5585 grams of iron powder contains 100 moles of iron, while the 11529 grams of 85% phosphoric acid solution contains 100 moles of phosphorus. The combination of the 1197 grams of lithium hydroxide and the 1847 grams of lithium carbonate contains 100 moles of lithium. These components are used to produce 100 moles of lithium iron phosphate.

Next, the 110.5 grams of glucose, the 1197 grams of lithium hydroxide (LiOH) and the 1847 grams of lithium carbonate (Li₂CO₃) are added to the mixing first slurry, and are reacted to form a second slurry. Subsequently, the second slurry is ground by a ball milling method to form a third slurry. During the grinding process, a liquid cooling method is performed to control the temperature of the second slurry through the cooling jacket of the tank. The temperature of the second slurry is maintained at 27° C. The third slurry has a median particle size (D50) of 1.0 μm.

Finally, the third slurry is dried and sintered to form a carbon-coated lithium iron phosphate. The third slurry is dried by a spray drying method, and is sintered at a temperature ranged from 550° C. and 750° C. in a nitrogen atmosphere for a duration of 10 hours to form a carbon-coated lithium iron phosphate. The carbon-coated lithium iron phosphate material of the second demonstrative example is subjected to a BET specific surface area test, which yields a measured specific surface area of 9.40 cm²/g. The carbon-coated lithium iron phosphate material of the second demonstrative example is subjected to an elemental analysis, which yields a measured carbon content of 1.25%.

### Second Comparative Example

The manufacturing method of the second comparative example is roughly similar to that of the second demonstrative example. However, in the second comparative example, the temperature of the second slurry is maintained at 45° C. The carbon-coated lithium iron phosphate material of the second comparative example is subjected to a BET specific surface area test, which yields a measured specific surface area of 9.04 cm²/g. The carbon-coated lithium iron phosphate material of the second comparative example is subjected to an elemental analysis, which yields a measured carbon content of 1.11%.

Refer to table 2 below. Table 2 presents the slurry temperature (C), BET surface area (cm²/g), and carbon content (%) of the carbon-coated lithium iron phosphate materials of the second demonstrative example and the second comparative example. Compared to the target specification of the carbon content of 1.40%, the carbon loss rate of the carbon-coated lithium iron phosphate material of the second demonstrative example is 10.7%, while the carbon loss rate of the carbon-coated lithium iron phosphate material of the second comparative example is 20.7%. Obviously, the carbon loss of the second demonstrative example with the slurry temperature of 27° C. is lower than that of the second comparative example with the slurry temperature of 45° C., and the specific surface area of the carbon-coated lithium iron phosphate material of the second demonstrative example is higher than that of the second comparative example. Furthermore, the carbon loss of the second demonstrative example with the slurry temperature of 27° C. is even lower than that of the first demonstrative example with the slurry temperature of 25° C. Namely, by implementing the liquid cooling method through the water jacket to control the slurry temperature between 27° C. to 40° C., the consistency of the lithium source solubility in the slurry is ensured, while avoiding the oxidation and decomposition of the carbon source in the high-temperature environment. As a result, the carbon content of the carbon-coated lithium iron phosphate material is guaranteed, thereby enhancing the stability of the product quality.

TABLE 2

| | Slurry | Specific | Carbon |
|---|---|---|---|
| | temperature | surface area | content |
| Second demonstrative example | 27° C. | 9.40 cm²/g | 1.25% |
| Second comparative example | 45° C. | 9.04 cm²/g | 1.11% |

### Third Demonstrative Example

First, a first slurry, a carbon source and a lithium source are provided. The first slurry is formed by reacting 5585 grams of iron powder, 11529 grams of 85% phosphoric acid solution, and 40 liters of deionized water in a tank for a duration of 20 hours. In the third demonstrative example, target specifications for the carbon-coated lithium iron phosphate material include a weight of 1578 grams and a carbon content of 1.40%. Notably, during the sintering process, 50% of the carbon content is lost. Therefore, the carbon content in the carbon-coated lithium iron phosphate material is half of the carbon content in the third slurry. To achieve the target specification, 44.2 grams of carbon needs to be added as the carbon source. Furthermore, in the third demonstrative example, the carbon source is a glucose, where carbon atoms account for 40% of its molecular mass. Consequently, 110.5 grams of glucose is required to yield the desired 44.2 grams of carbon. The lithium source is 1197 grams of lithium hydroxide (LiOH) and 1847 grams of lithium carbonate (Li₂CO₃). The 5585 grams of iron powder contains 100 moles of iron, while the 11529 grams of 85% phosphoric acid solution contains 100 moles of phosphorus. The combination of the 1197 grams of lithium hydroxide and the 1847 grams of lithium carbonate contains 100 moles of lithium. These components are used to produce 100 moles of lithium iron phosphate.

Next, the 110.5 grams of glucose, the 1197 grams of lithium hydroxide (LiOH) and the 1847 grams of lithium carbonate (Li₂CO₃) are added to the mixing first slurry, and are reacted to form a second slurry. Subsequently, the second slurry is ground by a ball milling method to form a third slurry. During the grinding process, a liquid cooling method is performed to control the temperature of the second slurry through the cooling jacket of the tank. The temperature of the second slurry is maintained at 25° C. The third slurry has a median particle size (D50) of 1.0 μm.

Finally, the third slurry is dried and sintered to form a carbon-coated lithium iron phosphate. The third slurry is dried by a spray drying method, and is sintered at a temperature ranged from 550° C. and 750° C. in a nitrogen atmosphere for a duration of 10 hours to form a carbon-coated lithium iron phosphate. The carbon-coated lithium iron phosphate material of the third demonstrative example is subjected to a BET specific surface area test, which yields a measured specific surface area of 9.82 cm²/g. The carbon-coated lithium iron phosphate material of the third demonstrative example is subjected to an elemental analysis, which yields a measured carbon content of 1.24%.

### Fourth Demonstrative Example

The manufacturing method of the fourth demonstrative example is roughly similar to that of the third demonstrative example. However, in the fourth demonstrative example, the temperature of the second slurry is maintained at 35° C. The carbon-coated lithium iron phosphate material of the fourth demonstrative example is subjected to a BET specific surface area test, which yields a measured specific surface area of 10.08 cm²/g. The carbon-coated lithium iron phosphate material of the fourth demonstrative example is subjected to an elemental analysis, which yields a measured carbon content of 1.28%.

Refer to table 3 below. Table 3 presents the slurry temperature (° C.), BET surface area (cm²/g), and carbon content (%) of the carbon-coated lithium iron phosphate materials of the third demonstrative example and the fourth demonstrative example. Compared to the target specification of the carbon content of 1.40%, the carbon loss rate of the carbon-coated lithium iron phosphate material of the third demonstrative example is 11.4%, while the carbon loss rate of the carbon-coated lithium iron phosphate material of the fourth demonstrative example is 8.6%. Obviously, the carbon loss of the fourth demonstrative example with the slurry temperature of 35° C. is lower than that of the third demonstrative example with the slurry temperature of 25° C., and the specific surface area of the carbon-coated lithium iron phosphate material of the fourth demonstrative example is higher than that of the third demonstrative example. Namely, by implementing the liquid cooling method through the water jacket to control the slurry temperature between 27° C. to 35° C., the consistency of the lithium source solubility in the slurry is ensured, while avoiding the oxidation and decomposition of the carbon source in the high-temperature environment. As a result, the carbon content of the carbon-coated lithium iron phosphate material is guaranteed, thereby enhancing the stability of the product quality.

TABLE 3

| | Slurry | Specific | Carbon |
|---|---|---|---|
| | temperature | surface area | content |
| Third demonstrative example | 25° C. | 9.82 cm²/g | 1.24% |
| Fourth demonstrative example | 35° C. | 10.08 cm²/g | 1.28% |

### Fifth Demonstrative Example

First, a first slurry, a carbon source and a lithium source are provided. The first slurry is formed by reacting 5585 grams of iron powder, 11529 grams of 85% phosphoric acid solution, and 40 liters of deionized water in a tank for a duration of 20 hours. In the fifth demonstrative example, target specifications for the carbon-coated lithium iron phosphate material include a weight of 1578 grams and a carbon content of 1.20%. Notably, during the sintering process, 50% of the carbon content is lost. Therefore, the carbon content in the carbon-coated lithium iron phosphate material is half of the carbon content in the third slurry. To achieve the target specification, 37.9 grams of carbon needs to be added as the carbon source. Furthermore, in the fifth demonstrative example, the carbon source is a glucose, where carbon atoms account for 40% of its molecular mass. Consequently, 94.7 grams of glucose is required to yield the desired 37.9 grams of carbon. The lithium source is 1197 grams of lithium hydroxide (LiOH) and 1847 grams of lithium carbonate (Li₂CO₃). The 5585 grams of iron powder contains 100 moles of iron, while the 11529 grams of 85% phosphoric acid solution contains 100 moles of phosphorus. The combination of the 1197 grams of lithium hydroxide and the 1847 grams of lithium carbonate contains 100 moles of lithium. These components are used to produce 100 moles of lithium iron phosphate.

Next, the 94.7 grams of glucose, the 1197 grams of lithium hydroxide (LiOH) and the 1847 grams of lithium carbonate (Li₂CO₃) are added to the mixing first slurry, and are reacted to form a second slurry. Subsequently, the second slurry is ground by a ball milling method to form a third slurry. During the grinding process, a liquid cooling method is performed to control the temperature of the second slurry through the cooling jacket of the tank. The temperature of the second slurry is maintained at 25° C. The third slurry has a median particle size (D50) of 1.0 μm.

Finally, the third slurry is dried and sintered to form a carbon-coated lithium iron phosphate. The third slurry is dried by a spray drying method, and is sintered at a temperature ranged from 550° C. and 750° C. in a nitrogen atmosphere for a duration of 10 hours to form a carbon-coated lithium iron phosphate. The carbon-coated lithium iron phosphate material of the fifth demonstrative example is subjected to a BET specific surface area test, which yields a measured specific surface area of 8.97 cm²/g. The carbon-coated lithium iron phosphate material of the fifth demonstrative example is subjected to an elemental analysis, which yields a measured carbon content of 1.10%.

### Sixth Demonstrative Example

The manufacturing method of the sixth demonstrative example is roughly similar to that of the fifth demonstrative example. However, in the sixth demonstrative example, the temperature of the second slurry is maintained at 35° C. The carbon-coated lithium iron phosphate material of the sixth demonstrative example is subjected to a BET specific surface area test, which yields a measured specific surface area of 9.34 cm²/g. The carbon-coated lithium iron phosphate material of the fourth demonstrative example is subjected to an elemental analysis, which yields a measured carbon content of 1.11%.

Refer to table 4 below. Table 4 presents the slurry temperature (° C.), BET surface area (cm²/g), and carbon content (%) of the carbon-coated lithium iron phosphate materials of the fifth demonstrative example and the sixth demonstrative example. Compared to the target specification of the carbon content of 1.20%, the carbon loss rate of the carbon-coated lithium iron phosphate material of the fifth demonstrative example is 8.3%, while the carbon loss rate of the carbon-coated lithium iron phosphate material of the sixth demonstrative example is 7.5%. Obviously, the carbon loss of the sixth demonstrative example with the slurry temperature of 35° C. is lower than that of the fifth demonstrative example with the slurry temperature of 25° C., and the specific surface area of the carbon-coated lithium iron phosphate material of the sixth demonstrative example is higher than that of the fifth demonstrative example. Namely, by implementing the liquid cooling method through the water jacket to control the slurry temperature between 27° C. to 35° C., the consistency of the lithium source solubility in the slurry is ensured, while avoiding the oxidation and decomposition of the carbon source in the high-temperature environment. As a result, the carbon content of the carbon-coated lithium iron phosphate material is guaranteed, thereby enhancing the stability of the product quality.

TABLE 4

| | Slurry | Specific | Carbon |
|---|---|---|---|
| | temperature | surface area | content |
| Fifth demonstrative example | 25° C. | 8.97 cm²/g | 1.10% |
| Sixth demonstrative example | 35° C. | 9.34 cm²/g | 1.11% |

In summary, the present disclosure provides a manufacturing method of a carbon-coated lithium iron phosphate material that effectively regulates the slurry temperature, thereby ensuring optimal carbon content and enhancing the stability of the product's quality. First, a carbon source, a lithium source, and a slurry formed from an iron source and a phosphorus source is provided. Next, the first slurry, the carbon source and the lithium source are mixed to form a second slurry. The second slurry is then ground in a tank at a temperature ranged from 25° C. to 40° C. to form a third slurry. Finally, the third slurry is dried and sintered to form a carbon-coated lithium iron phosphate material. By controlling the slurry temperature within a specific temperature range, the consistency of the lithium source solubility in the slurry is ensured, while avoiding the oxidation and decomposition of the carbon source in the high-temperature environment. As a result, the carbon content of the carbon-coated lithium iron phosphate material is guaranteed, thereby enhancing the stability of the product quality. Furthermore, the slurry temperature is controlled by employing liquid cooling method through a cooling jacket. The cooling jacket surrounds the internal space of the tank where the slurry is accommodated, ensuring smooth and uniform temperature control, thereby further enhances the stability of the product quality.

While the disclosure has been described in terms of what is presently considered to be the most practical and preferred embodiments, it is to be understood that the disclosure needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A manufacturing method of a carbon-coated lithium iron phosphate material, comprising steps of:
(a) providing a first slurry, a carbon source and a lithium source, wherein the first slurry is formed from an iron source and a phosphorus source;
(b) mixing the first slurry, the carbon source and the lithium source to form a second slurry, and grinding the second slurry in a tank at a first temperature to form a third slurry, wherein the first temperature is ranged from 25° C. to 40° C.; and
(c) drying and sintering the third slurry to form the carbon-coated lithium iron phosphate material including a core layer and a coating layer coated on the core layer, wherein the core layer is formed from the lithium source, the iron source and the phosphorus source, wherein the coating layer is formed from the carbon source.

2. The manufacturing method of the carbon-coated lithium iron phosphate material according to claim 1, wherein a liquid cooling method is performed to control the first temperature.

3. The manufacturing method of the carbon-coated lithium iron phosphate material according to claim 2, wherein the tank further comprises a first chamber and a cooling jacket, wherein the second slurry and the third slurry are accommodated in the first chamber for mixing and grinding, the cooling jacket is disposed to surround the first chamber, and the liquid cooling method is performed through the cooling jacket.

4. The manufacturing method of the carbon-coated lithium iron phosphate material according to claim 3, wherein the cooling jacket comprises at least two channels and a second chamber, wherein the second chamber is connected between at least two channels and disposed to surround the first chamber, and a liquid flows into and out of the second chamber through the at least two channels

5. The manufacturing method of the carbon-coated lithium iron phosphate material according to claim 1, wherein the carbon source, the lithium source and the first slurry are ground by a ball milling method.

6. The manufacturing method of the carbon-coated lithium iron phosphate material according to claim 1, wherein the second slurry and the third slurry are alkaline.

7. The manufacturing method of the carbon-coated lithium iron phosphate material according to claim 1, wherein the iron source comprises an iron powder, the phosphorus source comprises a phosphoric acid solution, and the iron powder and the phosphoric acid solution are reacted to form the first slurry.

8. The manufacturing method of the carbon-coated lithium iron phosphate material according to claim 1, wherein the third slurry is dried by a spray drying method.

9. The manufacturing method of the carbon-coated lithium iron phosphate material according to claim 1, wherein the third slurry is sintered at a sintering temperature ranged from 550° C. to 750° C.

10. The manufacturing method of the carbon-coated lithium iron phosphate material according to claim 1, wherein the third slurry is sintered in a non-oxidizing atmosphere.

11. The manufacturing method of the carbon-coated lithium iron phosphate material according to claim 1, wherein the carbon-coated lithium iron phosphate material has a carbon content ranged from 1.0% to 1.6%.
